(19) United States
(12) Patent Application Publication
(10) Pub. No.: US 2026/0189873 A1
(43) Pub. Date: Jul. 2, 2026

(54) PREMISES MONITORING SYSTEM WITH GEO-FENCE MONITORING

(71) Applicant: The ADT Security Corporation, Boca Raton, FL (US)

(72) Inventor: Harry SAMMLER, Warrington, PA (US)

(21) Appl. No.: 19/004,934

(22) Filed: Dec. 30, 2024

(51) Int. Cl. H04W 4/021; B60R 25/01; B60R 25/104

(52) U.S. Cl. CPC H04W 4/021; B60R 25/01; B60R 25/104

(57) ABSTRACT

A mobile monitoring node is provided. The mobile monitoring node is removably attachable to a mobile entity and is configured with first positioning parameters that correspond to a first geo-fence. The mobile monitoring node is configured to: monitor a location of the mobile monitoring node, causes transmission of an indication as to whether the mobile monitoring node is located within the first geo-fence, receive, from the control device, an action signal instructing the mobile monitoring node to initiate at least one action, the action signal being based on the indication; and initiate at least one action based on the action signal.

### TECHNICAL FIELD

The present technology is generally related to a premises monitoring system with geo-fence monitoring.

### BACKGROUND

Home burglar alarm systems and other types of premises monitoring systems can be used to monitor a premises for detectable events that may trigger an alarm or some other action when the premises monitoring system is in an armed state. However, some of these existing premises monitoring systems may suffer from “blind spots” at the premises that cannot be directly monitored. For example, these blind spots may include areas proximate to a home that is not within view or where the view is obstructed. That is, a camera such as a doorbell camera may not detect a situation, activity, or event that occurs outside of the premises in the blind spot(s) of the premises monitoring system. In another example, an existing premise monitoring system in a high-rise condo may monitor exit(s)/entrance(s) to the condo and within the condo itself but is unable to monitor other areas not proximate to the exit(s)/entrance(s) of the condo such the condo owner's parking spot.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a block diagram of an example system according to some embodiments of the present disclosure;

FIG. 2 is a block diagram of an example control device of the system of FIG. 1 according to various embodiments of the present disclosure;

FIG. 3 is a block diagram of example premises devices of the system of FIG. 1 according to various embodiments of the present disclosure;

FIG. 4 is a block diagram of an example mobile monitoring node of the system of FIG. 1 according to various embodiments of the present disclosure;

FIG. 5 is a block diagram of an example remote monitoring system of FIG. 1 according to various embodiments of the present disclosure;

FIG. 6 is a flowchart of an example process performed by one or entities of the system of FIG. 1 according to various embodiments of the present disclosure;

FIG. 7 is a flowchart of an example process performed by a mobile monitoring node of FIG. 1 according to various embodiments of the present disclosure;

FIG. 8 is a diagram of an example scenario according to various embodiments of the present disclosure; and

FIG. 9 is a diagram of another example scenario according to various embodiments of the present disclosure.

### DETAILED DESCRIPTION

The present disclosure relates to a premises monitoring system with geo-fence monitoring within, proximate, and not proximate to the premises.

In particular, a vehicle in a driveway or a parking spot may not be fully protected by the existing premises monitoring system using cameras (i.e., premises devices) because of obstacles like walls, shrubs, etc. block the field of view of the cameras. Therefore, the vehicle may be stolen or even broken into without detection.

One or more embodiments described herein resolves and/or addresses the problem with existing premises monitoring systems by, for example, using a method to protect a parking area (or areas) via the geo-fencing method/approach if, for example, a car key or FOB is not present, i.e., one or more rules are met. This approach may use a GPS beacon/module/node (e.g., mobile monitoring node) that can be installed in a vehicle, and that would inform the user that their vehicle is being tampered with and/or moved from their protected area.

In addition to being informed that their vehicle is being moved, the monitoring service could partner with a GPS tracking provider that would allow the user to track where their vehicle is being driven/taken to.

Additionally, the GPS node may support an accelerometer, as well as being a network node that could support additional devices on the vehicle that would allow a user to be alerted if their engine or trunk compartments are being tampered with, or someone hit their vehicle, or if someone attempted to break a window.

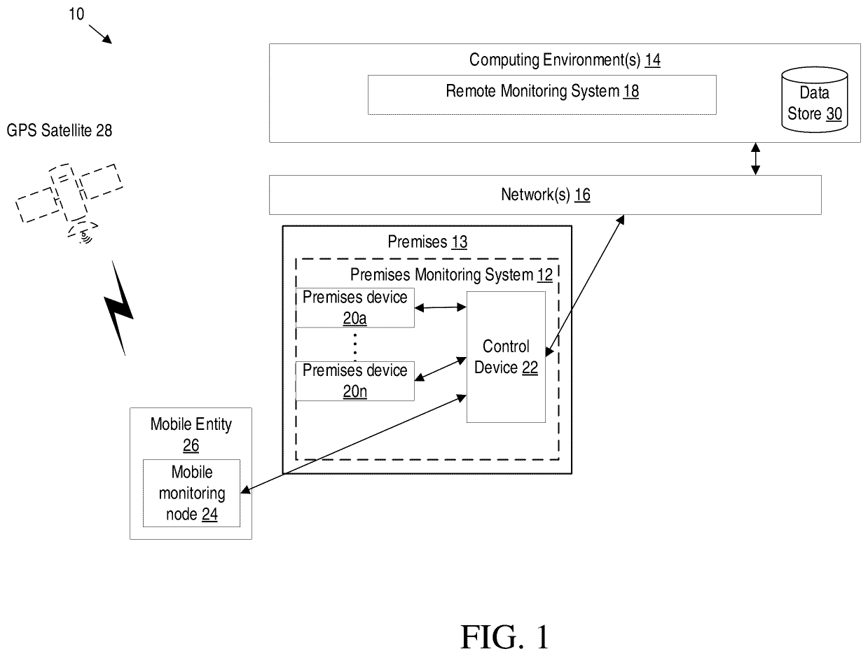

Referring now to the drawing figures, in which like elements are referred to by like reference numerals, there is shown in FIG. 1 a diagram of an example system 10 according to some embodiments of the present disclosure. System 10 may include premises monitoring system 12 and one or more computing environments 14 that may be in communication with each other via one or more networks 16 (collectively referred to as network 16). In embodiments described herein, the joining term, “in communication with” and the like, may be used to indicate electrical or data communication, which may be accomplished by physical contact, induction, electromagnetic radiation, radio signaling, infrared signaling or optical signaling, for example. Multiple components may interoperate and modifications and variations are possible to achieve the electrical and data communication. In some embodiments described herein, the term “coupled,” “connected,” and the like, may be used herein to indicate a connection, although not necessarily directly, and may include wired and/or wireless connections.

Premises monitoring system 12 may be configured to provide functionality relating to premises monitoring. For example, premises monitoring system 12 may be used to detect burglaries, smoke, fires, carbon monoxide leaks, water leaks, etc. and report detected events to remote monitoring system 18 of computing environment 14. Additionally, the premises monitoring functionality performed by premises monitoring system 12 may include home automation functionality. Examples of home automation functionality include thermostat control, door lock control, lighting control, appliance control, entertainment system control, etc.

Premises monitoring system 12 may include one or more premises devices 20a-20n (collectively referred to as “premises device 20”) for providing one or more of monitoring functionality, home automation functionality, etc. Premises device 20 may be in communication with control device 22 via one or more networks such as, for example, a local area network at premises 13 and/or short range wireless protocol network (e.g., BLUETOOTH, BLUETOOTH LOW ENERGY (BLE), ultra-wideband (UWB), ZIGBEE, Z-WAVE, among other Institute of Electrical and Electronics Engineers (IEEE) based short range wireless protocols, etc.).

Premise device 20 may include one or more sensors, devices configured to capture audio, images, and/or video, and/or other devices. For example, premises devices 20 may include motion sensors, fire sensors, smoke sensors, heat sensors, carbon monoxide sensors, flood sensors, flow sensors, temperature sensors, humidity sensors, proximity sensors, contact sensors, glass break sensors, water consumption sensors, water pressure sensors, etc. Devices configured to capture audio, images, and/or video may include still image cameras, video cameras, microphones, etc. Additional examples of premises devices 20 include sirens, garage door controllers, smart doorbells (e.g., video doorbell camera configured to capture audio, images and/or video), temperature sensors, humidity sensors, lighting devices, switches, electrical outlets, door locks, premises locks, and electrical plugs. For example, a video doorbell camera may be configured to identify or recognize a specific person in a video generated by the video doorbell camera.

Premises device 20 may include one or more user interface devices (not shown) that are in communication with control device 22. The user interface device may include a user interface, such as one or more buttons, a touch screen, a display, a microphone, a speaker, and/or other types of user interface components. According to various embodiments, the user interface device may be, for example, a keypad device, such as a wall-mountable keypad device configured to be installed near an entrance of the premises 13, that a user may operate to arm and disarm the premises monitoring system 12. In one or more embodiments, one or more premises devices 20, including but not limited to user interface devices, may include a dedicated short-range wireless communication protocol radio. For example, a dedicated short-range wireless communication protocol device may be located proximate to an entry or access point to premises 13 where premises devices 20 and/or mobile monitoring node 24 communicate with the dedicated short-range wireless communication protocol device, and the dedicated short-range wireless communication protocol device communicates with the user interface.

System 10 further comprises control device 22 that may be configured to control various aspects of premises monitoring system 12 and/or communicate with remote monitoring system 18. According to various embodiments, the control device 22 may be, or include, a wall-mountable panel device (e.g., a wall-mounted alarm system panel), a tabletop panel device (e.g., a tabletop alarm system panel), an alarm control panel having an enclosure and hinged door configured to be mounted in a closet, etc. Further, the control device 22 may have a short-range wireless communication radio that facilitates communication with one or more premises devices 20 and/or other devices via one or more short-range wireless communication protocols. Further, in some embodiments, control device 22 is configured to communicate with one or more mobile monitoring nodes 24 (described below) via short-range wireless communication and/or other wireless communications (e.g., WI-FI, cellular, etc.). Control device 22 may be configured to control premises devices 20, such as locks (e.g., electronic door locks), doors, windows, actuators, valves, motors, and any other controllable devices associated with premises monitoring system 12. According to various embodiments, control device 22 may be a gateway device, an alarm system panel, a hub and/or another type of device configured to control aspects of premises monitoring system 12.

Further, control device 22 is configured to analyze location information received from mobile monitoring node 24 with respect to at least one alarm criterion. For example, control device 22 may receive an indication that mobile monitoring node 24 is within or outside of a geo-fence such that control device 22 may initiate a security system action based at least on this indication, as described herein.

Further, system 10 includes mobile monitoring node 24 that is configured to communicate directly or indirectly with control device 22 via short range and/or long range wireless communication protocols, thereby configuring mobile monitoring node 24 to, for example, send geo-fenced based information (e.g., indications) to control device 22, as described herein. Further, mobile monitoring node 24 may be configured to receive one or more wireless positioning signals from one or more entities (e.g., Global Positioning Satellite (GPS) 28, etc.). Mobile monitoring node 24 is configured to be removably attachable and/or removably connectable to mobile entity 26 for monitoring the position and/or location of the mobile entity. For example, mobile monitoring node 24 is configured to monitor the location of mobile entity 26 with respect to at least one positioning parameter that corresponds to at least one geo-fence, as described herein.

Also, in one or more embodiments, mobile monitoring node 24 may be configured to modify one or more aspects of mobile entity 26. For example, mobile monitoring node 24 may be electrically connected to a vehicle (e.g., mobile entity 26) via one or more electrical ports in the vehicle that allow communication with the Engine Control Unit (ECU) and/or other onboard computers of the vehicle, e.g., via an on-board diagnostics (OBD) interface. Mobile monitoring node 24 may be configured to initiate a kill switch in the vehicle to disable the vehicle. In another example, mobile monitoring node 24 may be configured to modify at least one configuration of mobile entity 26 such as, for example, cause a horn of the vehicle to periodically honk or activate, or switch the A/C in the vehicle to a “heat” setting, thereby attempting to make a car theft uncomfortable enough to leave the vehicle.

While mobile entity 26 has been described as a vehicle such as a car, mobile entity 26 may correspond to a boat, bicycle, motorcycle, aircraft, off-road vehicle, locomotive, tractor, construction equipment, among other user-operated modes of transportation.

Further, computing environment 14 may include remote monitoring system 18 and data store 30. Remote monitoring system 18 may be configured to provide remote monitoring services for multiple premises monitoring systems 12. For example, in the event that an open door, open window, glass break, etc. is detected by a premises device 20 when premises monitoring system 12 is in an armed state, premises monitoring system 12 may transmit an alarm signal to remote monitoring system 18. In another example, in the event that mobile monitoring node 24 is located outside or inside of the geo-fence, the premises monitoring system 12 may transmit an alarm signal to remote monitoring system 18. In response, remote monitoring system 18 and/or a human monitoring agent associated with remote monitoring system 18 may notify first responders, such as police, fire, emergency medical responders, etc., and/or one or more designated peoples associated with the premise monitoring system 12. According to various embodiments, the notification can be a telephone call, an electronic message, etc. to a public-safety answering point (PSAP) that handles communications for first responders.

Data store 30 may be configured to store various information and/or data such as, for example, an alarm criterion, positioning parameters, etc. For example, data store 30 may store at least one alarm criterion (e.g., a rule) that specifies one or more conditions for analyzing location information received from mobile monitoring node 24. In some embodiments, control device 22 may receive the at least one alarm criterion from computing environment 14.

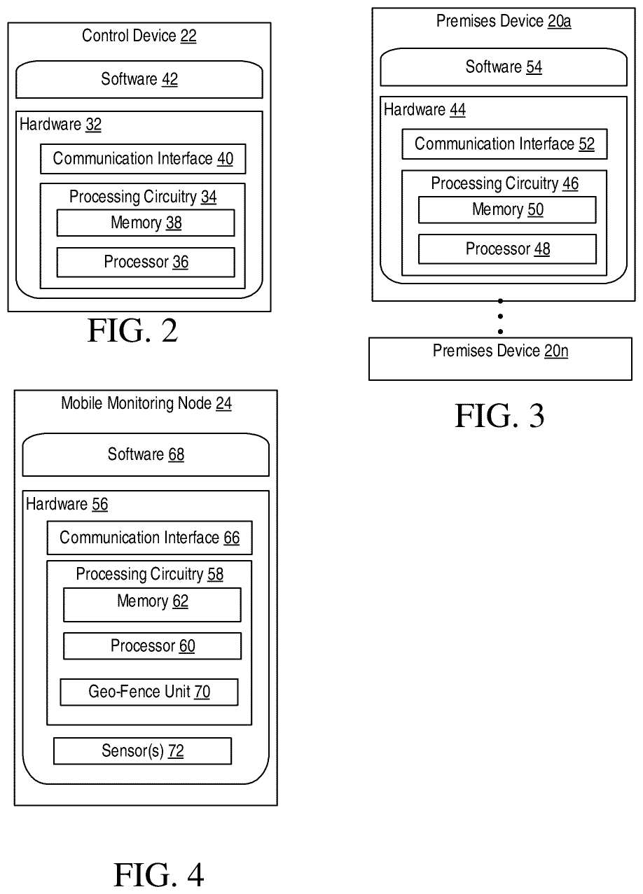

FIG. 2 shows a block diagram illustrating an example control device 22 of premises monitoring system 12. As shown, control device 22 comprises hardware 32. The hardware 32 may include processing circuitry 34. The processing circuitry 34 may include one or more processors 36 and one or more memories 38. Each processor 36 may include and/or be associated with one or more central processing units, data buses, buffers, and interfaces to facilitate operation. In addition to or instead of a processor 36 and memory 38, the processing circuitry 34 may comprise other types of integrated circuitry that perform various functionality. Integrated circuitry may include one or more processors 36, processor cores, field programmable gate arrays (FPGAs), application specific integrated circuits (ASICs), graphics processing units (GPUs), systems on chips (SoCs), or other components configured to execute instructions. The processor 36 may be configured to access (e.g., write to and/or read from) the memory 38, which may comprise any kind of volatile and/or nonvolatile memory, e.g., cache, buffer memory, random access memory (RAM), read-only memory (ROM), optical memory, and/or erasable programmable read-only memory (EPROM). Further, memory 38 may be embodied in the form of one or more storage devices. The processing circuitry 34 may be configured to perform various functionality described herein. For example, computer instructions may be stored in memory 38 and/or another computer-readable medium that, when executed by processor 36, causes the processor 36 to perform various functionality described herein.

Hardware 32 may include communication interface 40 facilitating communication between control device 22 and one or more elements in system 10. For example, communication interface 40 may be configured for establishing and maintaining at least a wireless or wired connection with one or more elements of system 10 such as with one or more of premises device 20, computing environment 14 and mobile monitoring node 24.

Control device 22 further has software 42 (which may include one or more software applications) stored internally in, for example, memory 38, or stored in external memory (e.g., database, storage array, network storage devices, etc.) accessible by the control device 22 via an external connection. Software 42 may include any software or program that configures processing circuitry 34 to perform the steps or processes of the present disclosure.

The processing circuitry 34 may be configured to control any of the methods and/or processes described herein and/or to cause such methods, and/or processes to be performed, e.g., by control device 22. One or more processors 36 may cause control device 22 to perform the functionality described herein. The memory 38 is configured to store data, including but not limited to files, data, at least one alarm criterion, other data, etc. In some embodiments, the software 42 may include instructions that, when executed by the processor 36 and/or processing circuitry 34, causes the processor 36 and/or processing circuitry 34 to perform the processes described herein with respect to control device 22. Accordingly, by having computer instructions stored in memory 38 accessible to the processor 36, the processor 36 may be configured to perform the actions, determinations, etc. that are described herein.

FIG. 3 is a block diagram illustrating premises devices 20a-n (referred to collectively herein as premises devices 20) according to some embodiments of the present disclosure. As shown, premises device 20a comprises hardware 44. The hardware 44 may include processing circuitry 46. The processing circuitry 46 may include one or more processors 48 (e.g., one or more premises device processors) and one or more memories 50. Each processor 48 may include and/or be associated with one or more central processing units, data buses, buffers, and interfaces to facilitate operation. In addition to or instead of a processor 48 and memory 50, the processing circuitry 46 may comprise other types of integrated circuitry that perform various functionality. Integrated circuitry may include one or more processors 48, processor cores, FPGAs, ASICs, GPUs, SoCs, or other components configured to execute instructions. The processor 48 may be configured to access (e.g., write to and/or read from) the memory 50, which may comprise any kind of volatile and/or nonvolatile memory, e.g., cache, buffer memory, RAM, ROM, optical memory, and/or EPROM. Further, memory 50 may be embodied in the form of one or more storage devices. The processing circuitry 46 may be configured to perform various functionality described herein. For example, computer instructions may be stored in memory 50 and/or another computer-readable medium that, when executed by processor 48 causes the processor 48 to perform various functionality associated with premises device 20a.

Hardware 44 may include communication interface 52 facilitating communication between premises device 20a and one or more elements in system 10. For example, communication interface 52 may be configured for establishing and maintaining at least a wireless or wired connection with one or more elements of system 10 such as control device 22 and/or computing environment 14.

Premises device 20a further has software 54 (which may include one or more software applications) stored internally in, for example, memory 50, or stored in external memory (e.g., database, storage array, network storage devices, etc.) accessible by the premises device 20a via an external connection. Software 54 may include any software or program that configures processing circuitry 46 to perform the steps or processes of the present disclosure.

The processing circuitry 46 may be configured to control any of the methods and/or processes described herein and/or to cause such methods, and/or processes to be performed, e.g., by premises device 20a. Processor 48 corresponds to one or more processors 48 for performing premises device 20a functions described herein. The memory 50 is configured to store data and/or files and/or other information/data. In some embodiments, the software 54 may include instructions that, when executed by the processor 48 and/or processing circuitry 46, causes the processor 48 and/or processing circuitry 46 to perform the processes described herein with respect to premises device 20a. Accordingly, by having computer instructions stored in memory 50 accessible to the processor 48, the processor 48 may be configured to perform the actions.

One or more other premises device 20b-20n may include the same or similar hardware and software as described above with respect to premises device 20a.

Referring to FIG. 4, shown is a block diagram illustrating an example of mobile monitoring node 24. As shown, mobile monitoring node 24 comprises hardware 56. The hardware 56 may include processing circuitry 58. The processing circuitry 58 may include one or more processors 60 and one or more memories 62. Each processor 60 may include and/or be associated with one or more central processing units, data buses, buffers, and interfaces to facilitate operation. In addition to or instead of a processor 60 and memory 62, the processing circuitry 58 may comprise other types of integrated circuitry that perform various functionality. Integrated circuitry may include one or more processors 60, processor cores, FPGAs, ASICs, GPUs, SoCs, or other components configured to execute instructions. The processor 60 may be configured to access (e.g., write to and/or read from) the memory 62, which may comprise any kind of volatile and/or nonvolatile memory, e.g., cache, buffer memory, RAM, ROM, optical memory, and/or EPROM. Further, memory 62 may be embodied in the form of one or more storage devices. The processing circuitry 58 may be configured to perform various functionality described herein. For example, computer instructions may be stored in memory 62 and/or another computer-readable medium that, when executed by processor 60, causes the processor 60 to perform various functionality described herein.

Hardware 56 may include one or more communication interfaces 66 facilitating communication between mobile monitoring node 24 and one or more elements in system 10. For example, communication interface 66 may be configured for establishing and maintaining at least a wireless or wired connection with one or more elements of system 10 such as with, for example, control device 22. In another example, communication interface 66 may be configured to receive one or more wireless (e.g., radio frequency (RF)) positioning signals from one or more entities (e.g., Global Positioning Satellite (GPS) 28, etc.).

Mobile monitoring node 24 further has software 68 stored internally in, for example, memory 62, or stored in external memory (e.g., database, storage array, network storage devices, etc.) accessible by the mobile monitoring node 24 via an external connection. Software 68 may include any software or program that configures processing circuitry 58 to perform the steps or processes of the present disclosure. Software 68 may include one or more software applications (e.g., mobile application) for interfacing with mobile monitoring node 24.

The processing circuitry 58 may be configured to control any of the methods and/or processes described herein and/or to cause such methods, and/or processes to be performed, e.g., by mobile monitoring node 24. One or more processors 60 may cause mobile monitoring node 24 to perform the functionality described herein. The memory 62 is configured to store data, including but not limited to files and/or other data. In some embodiments, the software 68 may include instructions that, when executed by the processor 60 and/or processing circuitry 58, causes the processor 64 and/or processing circuitry 58 to perform the processes described herein with respect to mobile monitoring node 24. For example, processing circuitry 58 may include a geo-fence unit 70 that is configured to perform one or more geo-fence based functions as described herein. Accordingly, by having computer instructions stored in memory 62 accessible to the processor 60, the processor 60 may be configured to perform the actions described herein.

Further, mobile monitoring node 24 may include one or more sensors 72 for performing one or more measurements and/or sensing one or more conditions. For example, sensor 72 may include one or more of at least one accelerometer, at least one glass-break sensor, at least one altimeter, etc. The sensor data from one or more of these various sensors 72 may be transmitted to control device 22 for use in determining whether to initiate at least one action. Further, while not shown, mobile monitoring node 24 may include one or more batteries for powering mobile monitoring node 24. Alternatively, mobile monitoring node 24 may be powered by the mobile entity 26 such as by electrically connecting to mobile entity 26.

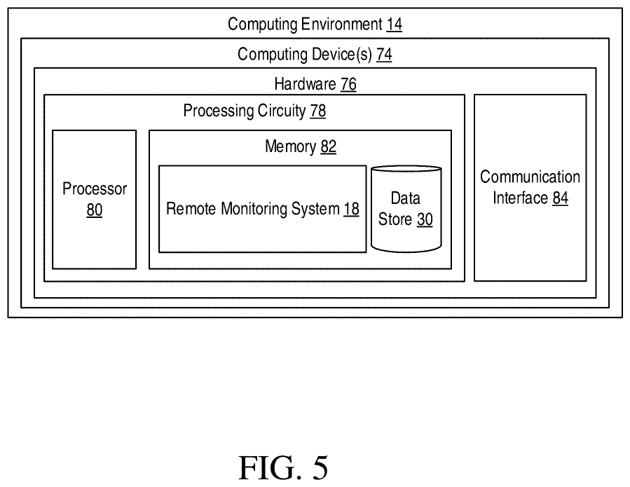

FIG. 5 is a block diagram illustrating the example computing environment 14 according to various embodiments. As shown, the computing environment 14 may include one or more computing devices 74. In embodiments using multiple computing devices 74, the computing devices 74 may be located in a single installation or may be distributed among many different geographic locations. As shown, each computing device 74 comprises hardware 76. The hardware 76 may include processing circuitry 78. The processing circuitry 78 may include one or more processors 80 and one or more memories 82. Each processor 80 may include and/or be associated with one or more central processing units, data buses, buffers, and interfaces to facilitate operation. In addition to or instead of a processor 80 and memory 82, the processing circuitry 78 may comprise other types of integrated circuitry that perform various functionality. Integrated circuitry may include one or more processors 80, processor cores, FPGAs, ASICs, GPUs, SoCs, or other components configured to execute instructions. The processor 80 may be configured to access (e.g., write to and/or read from) the memory 82, which may comprise any kind of volatile and/or nonvolatile memory, e.g., cache, buffer memory, RAM, ROM, optical memory, and/or EPROM. Further, memory 82 may be embodied in the form of one or more storage devices. The processing circuitry 78 may be configured to perform various functionality described herein. For example, computer instructions may be stored in memory 82 and/or another computer-readable medium that, when executed by processor 80, causes the processor 80 to perform various functionality.

Hardware 76 may include communication interface 84 facilitating communication between one or more elements in system 10. For example, communication interface 84 may be configured for establishing and maintaining at least a wireless or wired connection with one or more elements of system 10 such as control devices 22, premises devices 20, etc.

The processing circuitry 78 may be configured to control any of the methods and/or processes described herein and/or to cause such methods, and/or processes to be performed, e.g., in computing environment 14. Processor 80 corresponds to one or more processors 80 for performing computing device 74 functions described herein.

The memory 82 is configured to store data, such as files, remote monitoring system data, at least one alarm criterion, positioning parameters and/or other information/data. Also stored in the memory 82 and executable by the processor 80 is the remote monitoring system 18. Although FIG. 5 shows the remote monitoring system 18 being in a single computing device 74, the remote monitoring system 18 may execute in multiple computing devices 74 of the computing environment 14. To perform the functionality of the remote monitoring system 18, the memory 82 may include instructions that, when executed by the processor 80 and/or processing circuitry 78, causes the computing device 74 to perform the functionality performed by the remote monitoring system 18 described herein.

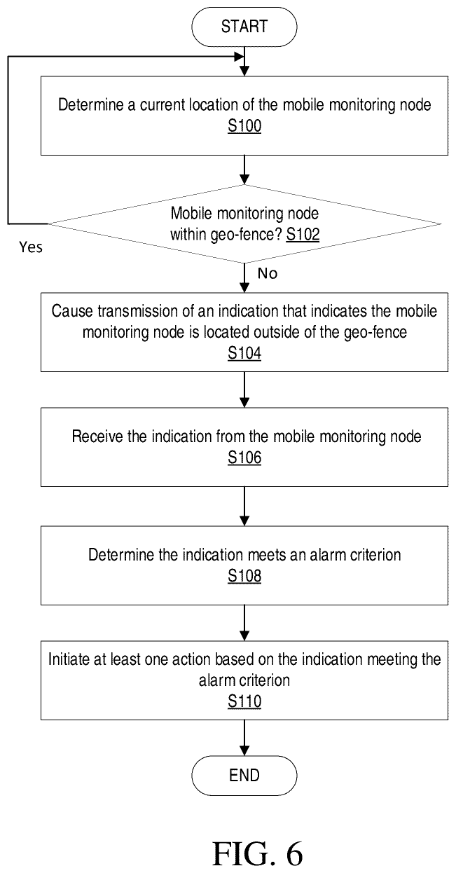

FIG. 6 is a flow chart of an example process implemented by one or more entities in system 10 according to some embodiments of the present disclosure. One or more mobile monitoring node 24 functions described below may be performed by one or more of processing circuitry 58, processor 60, geo-fence unit 70, communication interface 66, sensor 72, etc. One or more control device 22 functions described below may be performed by one or more of processing circuitry 34, processor 36, communication interface 40, etc. In one or more embodiments, mobile monitoring node 24 is removably attachable to and/or with mobile entity 26. In one or more embodiments, mobile monitoring node 24 is configured with one or more positioning parameters that corresponds to one or more geo-fences that are to be monitored by mobile monitoring node 24.

Mobile monitoring node 24 is configured to determine (Block S100) a current location of the mobile monitoring node 24, as described herein. Mobile monitoring node 24 is configured to determine (Block S102) whether mobile monitoring node 24 is within a geo-fence, as described herein. If the mobile monitoring node 24 is within the geo-fence, the process may return to Block S100. If the mobile monitoring node 24 is outside of the geo-fence (e.g., area corresponding to the geo-fence), mobile monitoring node 24 is configured to cause (Block S104) transmission of an indication as to whether the mobile monitoring node 24 is located outside the geo-fence, as described herein. Control device 22 is configured to receive (Block S106) the indication from the mobile monitoring node 24, as described herein. Control device 22 is configured to determine (Block S108) the indication meets an alarm criterion, as described herein. Control device 22 is configured to initiate (Block S110) at least one action based on the indication meeting the alarm criterion, as described herein.

According to one or more embodiments, the at least one action comprises one or both of initiating a premises alarm at the premises and activating a disable mode of the mobile entity 26 to disable the mobile entity.

According to one or more embodiments, mobile monitoring node 24 may transmit an indication when mobile monitoring node 24 is within the geo-fence.

According to one or more embodiments, the mobile monitoring node 24 is configured with second positioning parameters that correspond to a second geo-fence, and the processing circuitry 58 of the mobile monitoring node 24 is further configured to: monitor the location of mobile monitoring node 24 with respect to the second geo-fence, determine that the current location of the mobile monitoring node 24 is within the second geo-fence, in response to the determination, dynamically shift to monitoring the location of the mobile monitoring node 24 with respect to the first geo-fence, the first geo-fence being located within the second geo-fence, and the causing of transmission of the indication being based on the monitoring of the location of the mobile monitoring node 24 with respect to the first geo-fence.

According to one or more embodiments, the processing circuitry 58 of the mobile monitoring node 24 is further configured to receive Global Positioning System (GPS) signaling, where the determining of the current location of the mobile monitoring node 24 is based on the GPS signaling.

According to one or more embodiments, the mobile entity 26 is a boat or vehicle.

According to one or more embodiments, the mobile monitoring node 24 is located in an area that is not monitored by the control device 22.

According to one or more embodiments, the mobile monitoring node 24 is configured to communicate with the control device 22 of the premises monitoring system 12 via one or more of cellular and WI-FI.

According to one or more embodiments, the mobile monitoring node 24 further comprises one or more of: at least one accelerometer, glass-break sensor and altimeter, where the indication comprises data related to one or more of the at least one accelerometer, glass-break sensor and altimeter, and the alarm criterion comprising one or more thresholds for analyzing the data.

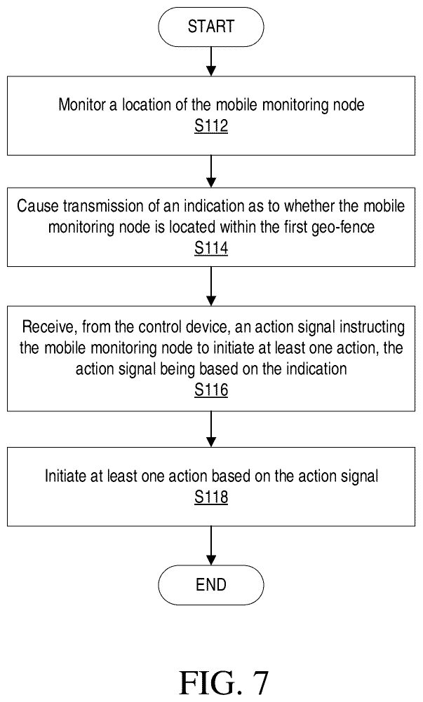

FIG. 7 is a flow chart of an example process implemented by mobile monitoring node 24 according to some embodiments of the present disclosure. One or more mobile monitoring node 24 functions described below may be performed by one or more of processing circuitry 58, processor 60, geo-fence unit 70, communication interface 66, sensor 72, etc. In one or more embodiments, mobile monitoring node 24 is removably attachable to and/or with mobile entity 26. In one or more embodiments, mobile monitoring node 24 is configured with one or more positioning parameters that correspond to one or more geo-fences that are to be monitored by mobile monitoring node 24.

Mobile monitoring node 24 is configured to monitor (Block S112) a location of the mobile monitoring node 24 at least by, for example, determining a current location of the mobile monitoring node 24, and determining whether the mobile monitoring node 24 is located within the first geo-fence, as described herein. Mobile monitoring node 24 is configured to cause (Block S112) transmission of an indication as to whether the mobile monitoring node 24 is located within the first geo-fence, as described herein. Mobile monitoring node 24 is configured to receive (Block S114), from the control device 22, an action signal instructing the mobile monitoring node 24 to initiate at least one action where the action signal is based on the indication, as described herein. Mobile monitoring node 24 is configured to initiate (Block S116) at least one action based on the action signal, as described herein.

According to one or more embodiments, the at least one action comprises activating a disable mode of the mobile entity 26 to disable the mobile entity 26.

According to one or more embodiments, the mobile monitoring node 24 is configured with second positioning parameters that correspond to a second geo-fence, and the processing circuitry 58 is further configured to: monitor the location of mobile monitoring node 24 with respect to the second geo-fence, determine that the current location of the mobile monitoring node 24 is within the second geo-fence, and in response to the determination, shift to monitoring the location of the mobile monitoring node 24 with respect to the first geo-fence, where the first geo-fence is located within the second geo-fence, and the causing of transmission of the indication is based on the monitoring of the location of the mobile monitoring node 24 with respect to the first geo-fence.

According to one or more embodiments, the processing circuitry 58 is further configured to receive Global Positioning System (GPS) signaling, the determining of the current location of the mobile monitoring node 24 being based on the GPS signaling.

According to one or more embodiments, the mobile entity 26 is a boat or vehicle.

According to one or more embodiments, the mobile monitoring node 24 is located in an area that is not monitored by the control device 22.

According to one or more embodiments, the mobile monitoring node 24 is configured to communicate with the control device 22 of the premises monitoring system 10 via one or more of cellular and WI-FI.

According to one or more embodiments, the mobile monitoring node 24 further comprises one or more of: at least one accelerometer, glass-break sensor and altimeter, where the indication comprises data related to one or more of the at least one accelerometer, glass-break sensor and altimeter. For example, mobile monitoring node 24 may include an accelerometer so that if the mobile entity 26 is bumped or broken into, mobile monitoring node 24 can report that activity to control device 22. Further, in one or more embodiments, mobile monitoring node 24 supports the detection of other activities or events such as, for example, a vehicle hood being opened/closed, a vehicle trunk being opened/closed, a vehicle window being broken and a kill switch to stop the engine from starting. Each of these activities is indicated to control device 22 by mobile monitoring node 24, and since mobile monitoring node 24 supports telephony and WI-FI networking capabilities, a device with mobile monitoring node 24 installed can be protected/monitored from various locations even when not proximate the premises 13.

For example, mobile monitoring node 24 can be used to monitor a user's boat that is located at their shore home or to monitor the user's vehicle at a mall parking lot.

In one or more embodiments, a user may be provided with the ability to sign-up for the GPS/geo-fence functionality with the premises monitoring service provider associated with computing environment 14. After sign-up, the premises monitoring service provider or the user creates a geo-fence around the mobile entity 26 by, for example, programing length, width and height of the mobile entity 26. The user is provided with mobile monitoring node 24 that the user can position and/or removably attach to mobile entity 26. Mobile monitoring node 24 tracks mobile entity 26 to determine if mobile entity 26 has moved outside the geo-fence, as described herein. At least one action may be initiated based on the determination. In one or more embodiments, computing environment 14 may track mobile entity 26 via a third-party tracking system.

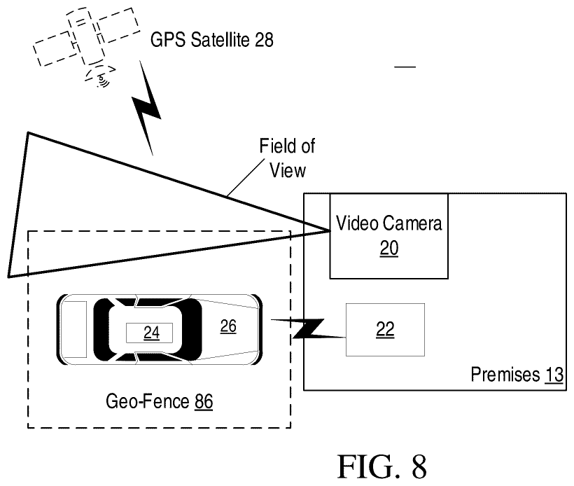

FIG. 8 is a diagram of an example scenario according to one or more embodiments of the present disclosure. In particular, mobile monitoring node 24 is removably attached and/or connected to mobile entity 26 (e.g., vehicle 26) where mobile monitoring node 24 is configured to monitor its location relative to geo-fence 86. In this scenario, vehicle 26 may be parked outside of premises 13, which is being monitored by premises monitoring system 12. Vehicle 26 may be out of view of video camera 20, such that monitoring of vehicle 26 may be performed by mobile monitoring node 24, as described herein.

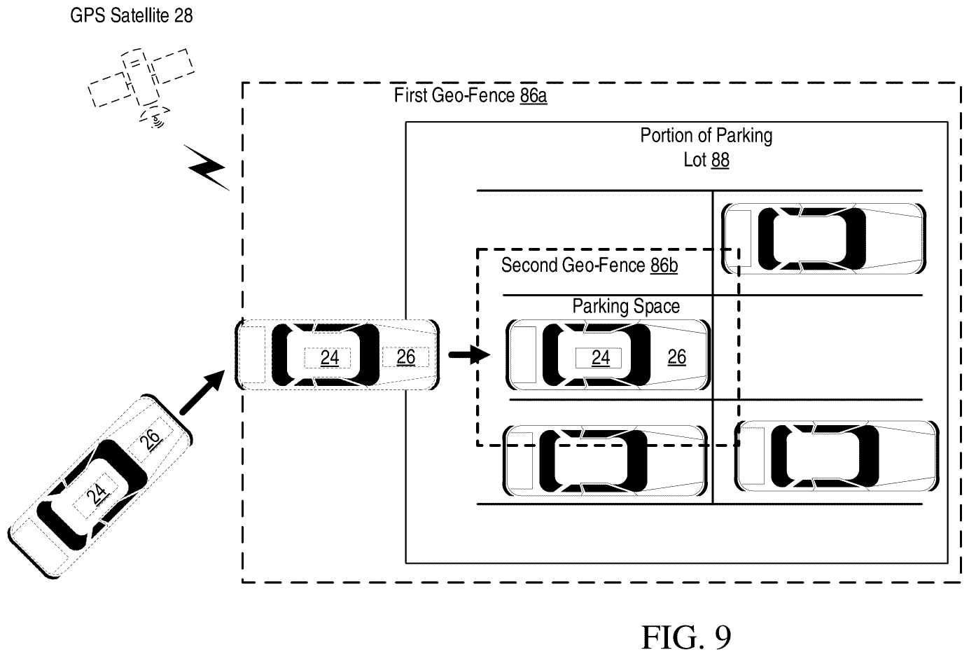

FIG. 9 is another scenario according to one or more embodiments of the present disclosure. In particular, in the scenario of FIG. 9, mobile monitoring node 26 is configured with first geo-fence 86a and second geo-fence 86b where second geo-fence 86b is located within first geo-fence 86a. In this scenario, mobile monitoring node 24 is configured to begin monitoring whether vehicle 26 has entered the first geo-fence 86a. If vehicle 26 has entered the first geo-fence 86a, as determined by mobile monitoring node 24, mobile monitoring node 26 is configured to transition or switch to monitoring the vehicle with respect to the second geo-fence 86b. That is, mobile monitoring node 24 dynamically switches to monitoring second geo-fence 86b based on vehicle 26 having entered parking lot 88 and parked in a specific parking spot. In another embodiment, the positioning parameters corresponding to geo-fence 86b may be dynamically determined by mobile monitoring node 24 after vehicle 26 has parked. Hence, mobile monitoring node 24 is advantageously able to initiate more precise monitoring.

In some embodiments, mobile monitoring node 24 may transition to monitoring the second geo-fence 86b based on one or more rules being met, such as, for example, determining that the car has been turned off or that the vehicle's alarm has been activated.

In one or more embodiments, mobile monitoring node 24 is configured to determine the geo-fence based on one or more predefined rules. For example, the geo-fence may be determined to be 10 feet radius from mobile monitoring node 24 where the location coordinates corresponding to the geo-fence may be determined after the vehicle has been turned off or stationary for a predefined amount of time, for example.

In one or more embodiments mobile monitoring node 24 is battery operated and connected to the vehicle's (e.g., mobile entity's) power source so that mobile monitoring node 24 is always active but can be placed in a sleep mode if the battery drain is an issue.

In one or more embodiments, mobile monitoring node 24 is connected to control device 22 via a WI-FI and/or Telephony network.

In one or more embodiments, mobile monitoring node 24 (e.g., GPS node) does not need to be local and/or proximate control device 22 to work. For example: The user can own a boat (e.g., type of mobile entity 26) that also can be protected at a dock.

Therefore, as described herein in one or more embodiments, instead of relying on the standard cameras to monitor a vehicle (e.g., type of mobile entity 26) in your driveway, a mobile monitoring node 24 is used that incorporates one or more of GPS, telephony, WI-FI, and an accelerometer, to which other sensors can connect. Using the mobile monitoring node 24, a user and/or a premises monitoring service provider can create and/or deploy a geo-fence around a vehicle, while the accelerometer in the mobile monitoring node 24 will detect any bumping or hitting of the vehicle. If optional sensors 72 are added, control device 22 and/or computing environment 14 will be able to detect tampering, such as the opening of the hood/trunk or the breaking of windows. If any activity is detected by the sensors 72, those events are transported by mobile monitoring node 24 to control device 22 via telephony and/or WI-FI, which then transfers it to computing environment 14, which then contacts first responders to handle the event. If the vehicle is stolen, the GPS may be activated, thus allowing the first responders to track the vehicle (e.g., via a third-party system).

In one or more embodiments, if the GPS is not working (i.e., mobile monitoring node 24 cannot receive or analyze GPS signals), mobile monitoring node 24 may failover to the WI-FI network, so that the vehicle's location can be located via WI-FI using triangularization (XYZ coordinates).

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects. Any process, step, action and/or functionality described herein may be performed by, and/or associated to, a corresponding module and/or unit, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings without departing from the scope and spirit of the present disclosure.

What is claimed is:

1. A system, comprising:
a mobile monitoring node configured to communicate with a control device of a premises monitoring system, the mobile monitoring node being removably attachable with a mobile entity and being configured with first positioning parameters that correspond to a first geo-fence, the mobile monitoring node comprising processing circuitry configured to:
determine a current location of the mobile monitoring node;
cause transmission of an indication as to whether the mobile monitoring node is located within the first geo-fence; and
the control device configured to monitor a premises and the mobile monitoring node, the control device comprising processing circuitry configured to:
receive the indication from the mobile monitoring node;
determine the indication meets an alarm criterion; and
initiate at least one action based on the indication meeting the alarm criterion.

2. The system of claim 1, wherein the at least one action comprises one or both of initiating a premises alarm at the premises and activating a disable mode of the mobile entity to disable the mobile entity.

3. The system of claim 1, wherein the mobile monitoring node is configured with second positioning parameters that correspond to a second geo-fence;
the processing circuitry of the mobile monitoring node is further configured to:
monitor the location of mobile monitoring node with respect to the second geo-fence;
determine that the current location of the mobile monitoring node is within the second geo-fence; and
in response to the determination, dynamically shift to monitoring the location of the mobile monitoring node with respect to the first geo-fence, the first geo-fence being located within the second geo-fence; and
the causing of transmission of the indication being based on the monitoring of the location of the mobile monitoring node with respect to the first geo-fence.

4. The system of claim 1, wherein the processing circuitry of the mobile monitoring node is further configured to receive Global Positioning System (GPS) signaling, the determining of the current location of the mobile monitoring node being based on the GPS signaling.

5. The system of claim 1, wherein the mobile entity is a boat or vehicle.

6. The system of claim 1, wherein the mobile monitoring node is located in an area that is not monitored by the control device.

7. The system of claim 1, wherein the mobile monitoring node is configured to communicate with the control device of the premises monitoring system via one or more of cellular and WI-FI.

8. The system of claim 1, wherein the mobile monitoring node further comprises one or more of:
at least one accelerometer;
glass-break sensor; and
altimeter;
the indication comprising data related to one or more of the at least one accelerometer, glass-break sensor and altimeter; and
the alarm criterion comprising one or more thresholds for analyzing the data.

9. A mobile monitoring node configured to communicate with a control device of a premises monitoring system, the mobile monitoring node being removably attachable to a mobile entity and being configured with first positioning parameters that correspond to a first geo-fence, the mobile monitoring node comprising:
processing circuitry configured to:
monitor a location of the mobile monitoring node at least by:
determining a current location of the mobile monitoring node; and
determining whether the mobile monitoring node is located within the first geo-fence;
cause transmission of an indication as to whether the mobile monitoring node is located within the first geo-fence;
receive, from the control device, an action signal instructing the mobile monitoring node to initiate at least one action, the action signal being based on the indication; and
initiate at least one action based on the action signal.

10. The mobile monitoring node of claim 9, wherein the at least one action comprises activating a disable mode of the mobile entity to disable the mobile entity.

11. The mobile monitoring node of claim 9, wherein the mobile monitoring node is configured with second positioning parameters that correspond to a second geo-fence;
the processing circuitry is further configured to:
monitor the location of mobile monitoring node with respect to the second geo-fence;
determine that the current location of the mobile monitoring node is within the second geo-fence; and
in response to the determination, shift to monitoring the location of the mobile monitoring node with respect to the first geo-fence, the first geo-fence being located within the second geo-fence; and
the causing of transmission of the indication being based on the monitoring of the location of the mobile monitoring node with respect to the first geo-fence.

12. The mobile monitoring node of claim 9, wherein the processing circuitry is further configured to receive Global Positioning System (GPS) signaling, the determining of the current location of the mobile monitoring node being based on the GPS signaling.

13. The mobile monitoring node of claim 9, wherein the mobile entity is a boat or vehicle.

14. The mobile monitoring node of claim 9, wherein the mobile monitoring node is located in an area that is not monitored by the control device.

15. The mobile monitoring node of claim 9, wherein the mobile monitoring node is configured to communicate with the control device of the premises monitoring system via one or more of cellular and WI-FI.

16. The mobile monitoring node of claim 9, wherein the mobile monitoring node further comprises one or more of:
at least one accelerometer;
glass-break sensor; and
altimeter;
the indication comprising data related to one or more of the at least one accelerometer, glass-break sensor and altimeter.

17. A method implemented by a mobile monitoring node that is configured to communicate with a control device of a premises monitoring system, the mobile monitoring node being removably attachable to a mobile entity and being configured with first positioning parameters that correspond to a first geo-fence, the method comprising:
monitoring a location of the mobile monitoring node at least by:
determining a current location of the mobile monitoring node; and
determining whether the mobile monitoring node is located within the first geo-fence;
causing transmission of an indication as to whether the mobile monitoring node is located within the first geo-fence;
receiving, from the control device, an action signal instructing the mobile monitoring node to initiate at least one action, the action signal being based on the indication; and
initiating at least one action based on the action signal.

18. The method of claim 17, wherein the at least one action comprises activating a disable mode of the mobile entity to disable the mobile entity.

19. The method of claim 17, wherein the mobile monitoring node is configured with second positioning parameters that correspond to a second geo-fence;
the method further comprising:
monitoring the location of mobile monitoring node with respect to the second geo-fence;
determining that the current location of the mobile monitoring node is within the second geo-fence; and
in response to the determination, shifting to monitoring the location of the mobile monitoring node with respect to the first geo-fence, the first geo-fence being located within the second geo-fence; and
the causing of transmission of the indication being based on the monitoring of the location of the mobile monitoring node with respect to the first geo-fence.

20. The method of claim 17, wherein the mobile monitoring node further comprises one or more of:
at least one accelerometer;
glass-break sensor; and
altimeter;
the indication comprising data related to one or more of the at least one accelerometer, glass-break sensor and altimeter.
